(19) United States
(12) Patent Application Publication
(10) Pub. No.: US 2022/0288610 A1
(43) Pub. Date: Sep. 15, 2022

(54) ATOMIZER AND ATOMIZATION SYSTEM USING THE SAME

(71) Applicant: OZYEGIN UNIVERSITESI, Istanbul (TR)

(72) Inventors: Gokhan KAYANSALCIK, Istanbul (TR); Ozgur ERTUNC, Istanbul (TR)

(73) Assignee: OZYEGIN UNIVERSITESI, Istanbul (TR)

(21) Appl. No.: 17/638,861

(22) PCT Filed: Aug. 28, 2019
(86) PCT No.: PCT/TR2019/050709

§ 371 Date: Feb. 28, 2022

(51) Int. Cl. B05B 3/02; B05B 7/00

(52) U.S. Cl. CPC B05B 3/022; B05B 7/0075

(57) ABSTRACT

An atomizer includes at least one body, a cylindrical lateral surface surrounding the at least one body and blades positioned in one piece on the cylindrical lateral surface at selected angles to enhance an atomization and at a selected distance to each other and the at least one body integrated with the at least one body that providing high velocity rotational motion to atomizer.

### CROSS REFERENCE TO THE RELATED APPLICATIONS

This application is the national stage entry of International Application No. PCT/TR2019/050709, filed on Aug. 28, 2019, the entire contents of which are incorporated herein by reference.

### TECHNICAL FIELD

The present invention relates to an atomizer providing transformation of a bulk liquid into a spray of liquid droplets in a surrounding gas or vacuum.

More specifically, the present invention relates to an atomizer having a high velocity rotating surface and a method for droplet atomization by high velocity rotating surface.

### BACKGROUND

There are many types of atomizers. The idea behind atomization is to make a thin liquid sheet or liquid jet and later disintegrate it either with natural instabilities (shear induced Kelvin-Helmoltz or density gradient induced-Rayleigh Taylor) or by inducing artificial instabilities by different means, such as blasting gas on the liquid sheet or jet emanating from a nozzle, creating pressure waves in the liquid.

Most of the atomizers pushes liquid through a nozzle with the help of a high pressure. Nozzle gives the liquid a certain direction and speed. Upon the liquid leaves the nozzle, natural or artificial instabilities cause atomization. In order to get very fine droplets, the nozzle should have geometric dimensions below 500 micrometer down to a few micrometers, which is very hard to manufacture with required tolerances. Moreover, in order to create very small droplets of highly viscous fluids, very high pressure has to be generated. If high pressure is used, atomizer should sustain the forces created by the pressure and replacement/maintenance period is significantly reduced. On the other hand, in rotary atomizers, the liquid is directed on a rotating surface and disintegration happens with the help of centrifugal force transferred to the liquid by viscous stresses between the liquid and the surface. Further instabilities are introduced by air-blasting to or around the rotating surface.

In summarized atomization of highly viscous liquids into very fine droplets (5-30 micrometers) becomes a challenge for classical atomizers because;
Very high pressures are needed and systems providing high pressures with high flow rates becomes very expensive
Injectors for fine atomization incorporates micron sized (<500 micrometers) geometric details which is still challenging to produce accurately.

The researches show that another way of atomization is impacting droplets on to a surface, which is either stationary or moving. However, in order to get very fine droplets upon impact on stationary surface, the droplet speed should be very high, i.e. while droplets are generated very high pressure levels has to be reached, especially for highly viscous fluids.

U.S. Pat. No. 06,102,862 discloses an electrostatic paint spray pistol with a rotary bell shaped atomizer head with a bell rim in the shape of a rounded circular arch from which paint may be centrifuged at various positions. This provides the advantage of being able to control rotating speed and paint throughput over a wide range.

U.S. Pat. No. 14,301,735 discloses a rotary atomizer for the even distribution of a treatment fluid within a treatment chamber. The treatment fluid is delivered onto a rotating disk atomizer through multiple outlet ports. Fluid passages provide each outlet port with an even flow of treatment fluid at generally the same time and rate. This even and simultaneous flow of treatment fluid results in a more even distribution of treatment fluid on the seed that flows through the treatment chamber throughout the treatment cycle.

Considering the complex and hard production atomization systems in the state of the art; there is still need an atomizer that can generate very fine droplets of highly viscous liquids such as molten metals, liquid food and paints and provide a simple device to increase the production of fine droplets and powders.

### SUMMARY

The main object of the present invention is providing an atomizer having high velocity rotating surface with a geometric properties for the transformation of a bulk liquid into a spray of liquid droplets in a surrounding gas or vacuum.

A further object of the present invention is to provide an even distribution of droplets using one or more rotating element in a fluid atomizer. A further object of the present invention is to provide a more reliable rotatable atomizer arrangement which is particularly adapted for controlled droplet generated systems.

A further object of the present invention is to provide a method that allows the control of the rotation speed to adjust atomized droplet diameter.

According to another embodiment of a present invention an atomizer comprises at least one body comprising a cylindrical lateral surface; a plurality of blades positioned outwardly on the cylindrical lateral surface; wherein when the atomizer rotates, droplets provided to rotating blades are atomized.

According to another embodiment of a present invention the body is in the form of a disc.

According to another embodiment of a present invention the blades are positioned at a selected angle and at a selected distance to each other.

According to another embodiment of a present invention an atomizer further comprises at least one connecting shaft which is integrated with the body for connecting the body to a rotary actuator.

According to another embodiment of a present invention an atomizer further comprising at least two body positioned coaxially with each other.

According to another embodiment of a present invention an atomization system comprises at least one atomizer, rotary actuator providing rotational motion to the atomizer and at least one droplet supplier for providing droplets to the rotating blades.

According to another embodiment of a present invention rotary actuator is configured to rotate the atomizer 20000 rpm to 200000 rpm.

According to another embodiment of a present invention the droplet supplier comprises at least one reservoir for keeping liquid to be atomized, at least one liquid valve for delivering the liquid from the reservoir to at least one droplet generator/spray generator/liquid jet wherein the droplet generator/spray generator/liquid jet is for generating droplets which is directed to the rotating blades.

According to another embodiment of a present invention the spray generator is a spray injector or spray nozzle.

According to another embodiment of a present invention a gas channel for blowing a gas on atomized droplets to direct atomized droplets.

According to another embodiment of a present invention the blowing gas is received form a gas reservoir.

According to another embodiment of a present invention at least one controller for regulating the rotational speed of the rotary actuator, rate of the generated droplets or controlling flow rate of blowing gas via a valve.

According to another embodiment of a present invention an atomization method comprising the steps of:
regulating the rotary actuator at a selected speed,
regulating rate of the generated droplets at a selected rate,
controlling flow rate of blowing gas,
atomizing the generated droplets by the blades of the rotating atomizer,
directing the atomized droplets by the blowing gas from the gas channel.

### BRIEF DESCRIPTION OF THE DRAWINGS

FIG. 1 is the top perspective view of the atomizer.

FIG. 2 is the front perspective view of the atomizer.

FIG. 3 is the front perspective view of the cascaded atomizer.

FIG. 4 is the flow chart of the atomization system.

FIG. 5 is range comparison of present invention by using different working fluid with literature.

1. Atomizer
   10. Body
   11. Cylindrical lateral surface
   12. Blade
   13. Connecting shaft

S: Atomization system
1. Atomizer
2. Rotary actuator
3. Droplet supplier
   30. Reservoir
   31. Liquid valve
   32. Droplet generator/spray generator/liquid jet
4. Gas reservoir
5. Valve
6. Gas channel
7. Controller

FIG. 5:

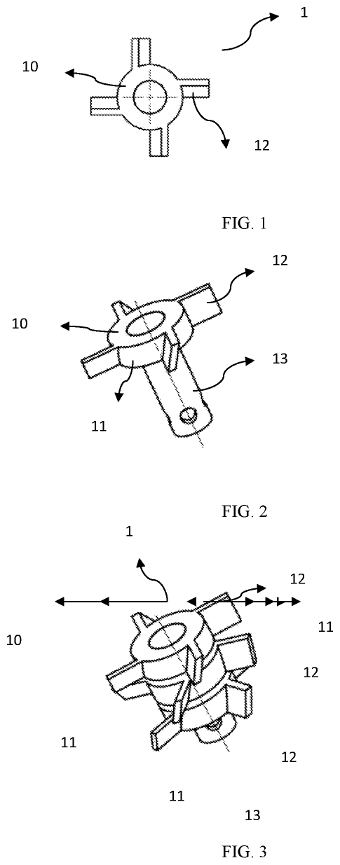

X: Weₜ

Y: Weₙ

A: Designed setup with water droplet

B: Cooper droplet

C: Iron droplet

D: Water droplet (Almohammadi and Amirfazli, 2017)

E: Aluminum droplet (About and Kietzig, 2015)

F: Aluminum droplet

G: Titanium droplet

H: Ethanol droplet (Bird, Tsai, & Stone, 2009)

### DETAILED DESCRIPTION OF THE EMBODIMENTS

This invention relates to an atomizer (1) which disintegrates droplets into smaller droplets, upon impact to the blades (12) rotating with very high speed.

In a preferred embodiment of the present invention, atomizer (1) comprises at least one body (10), a cylindrical lateral surface (11) surrounding the body (10) and multiple blades (12) positioned on the cylindrical lateral surface (11) wherein the blades (12) are positioned at a selected angle with the cylindrical lateral surface (11) and at a selected distance to each other to enhance atomization.

In a preferred embodiment of the present invention, the atomizer (10) further comprising at least two body (10) positioned coaxially with each other. Each body having multiple blades (12) positioned in one single piece on the cylindrical lateral surface (11) of the body (10).

In a preferred embodiment of the present invention, atomizer (1) further comprises at least one connecting shaft (13) integrated with the body (10) or multiple bodies(10) providing high velocity rotatable move to atomizer (1).

In a preferred embodiment of the present invention, the angle between the cylindrical lateral surface (11) and the blade (12) is modifiable according to the desired dispersion properties of the liquid droplets. The angle determines the ratio of viscous wall shear to impact inertia and consequently the atomization and final droplet diameter.

In a preferred embodiment of the present invention liquid droplets impact directly to the blades (12) and after they impact, surface tension of the droplet and intermolecular forces in the droplets cannot resist to the impact effect due to high velocity of the rotating blades (12) and droplet disintegrates into many smaller ones. The surface of blade (12) has certain geometric properties to stimulate atomization of droplets in to smaller droplets. It is also observed that the atomization depends on the liquid flow rate, the rotational speed of the body (10) and the angle between the cylindrical lateral surface (11) and blades (12) and the number of the blades (12).

In a preferred embodiment of the present invention; droplets are directed to blades' (12) surface for atomization which rotates at a very high angular speed. The surface of blade (12) is adjusted according to the physical properties of the liquid and the required droplet size after atomization.

In another preferred embodiment of the present invention; in atomizers (1) where more than one body (10) are coaxially integrated on the connecting shaft (13), each generated droplet is atomized to the desired size by subjecting multiple high velocity rotating blade (12) impacts.

In a preferred embodiment of the present invention, the surface properties such as wettability, roughness and surface patterns of the blade (12) play a decisive role in the atomization quality. These properties affect the applied surface forces to the droplets and provide the disintegrations of the droplets into many smaller ones. The surface properties of blades (12) such as roughness, texture, wettability, can be prepared to depend on the fluid properties for the desired atomization.

In a preferred embodiment of the present invention an atomization system (S) is provided wherein the system (S) comprises at least one rotary actuator (2) providing rotational motion to the atomizer (10) and at least one droplet supplier (3) for providing droplets to the rotating blades (12).

In a preferred embodiment of the present invention; the rotary actuator (2) can rotate the atomizer (1) in between 20000 rpm to 200000 rpm.

In a preferred embodiment of the present invention; the droplet supplier (3) comprises at least one reservoir (30) for keeping a liquid to be atomized, at least one liquid valve (31) for delivering the liquid from the reservoir (30) to at least one droplet generator/spray generator/liquid jet (32), wherein the droplet generator/spray generator/liquid jet (32) is for generating droplets which is directed to the rotating blades (12).

In a preferred embodiment of the present invention; the spray generator (32) is a spray injector or spray nozzle.

In a preferred embodiment of the present invention; the atomization system (S) further comprises a gas channel (6) for blowing a gas on atomized droplets to direct atomized droplets; a gas reservoir (4) is formed by the blowing gas, at least one valve (5) regulating the flow rate of the blowing gas and at least one controller (7) for regulating the rotational speed of the rotary actuator (2), rate of the generated droplets or controlling flow rate of blowing gas via a valve (5).

In a preferred embodiment of the present invention blades (12) are driven by a high-speed rotary actuator (2) rotating very fast. The rotary actuator (2) can rotate up 20000 rpm to 200000 rpm rotation speed. The speed is controlled by the controller (7). Liquid is supplied to the droplet generator/spray generator/liquid jet (32) from a reservoir (30) with the help of a liquid valve (31). The required flow rate is communicated to the liquid valve (31) by the computer (7). Droplet generator/spray generator/liquid jet (32) generates droplets either in a row or in the form of a spray, which is directed to the rotating blades (12). Droplets disintegrate into smaller droplets, upon impact to the blades (12) rotating with very high speed. Disintegration happens due to inertial thinning of droplet and viscous shear forces occurring on the blades' (12) surface.

The atomized droplets are directed by a gas flow with certain direction and speed. Gas laden with droplets, can be later either evaporated for chemical reactions like combustion or for the generation of particles if the liquid has solid components or cooled to obtain solid particles for example from liquid metals. The gas flow is supplied from gas reservoir (4). Its flow rate is regulated by a valve (5), which is controlled by a controller (7). After the valve (5) regulates the flow rate of the gas, the gas channel (6) is used to give direction and required speed to the gas, which is used to direct atomized droplets.

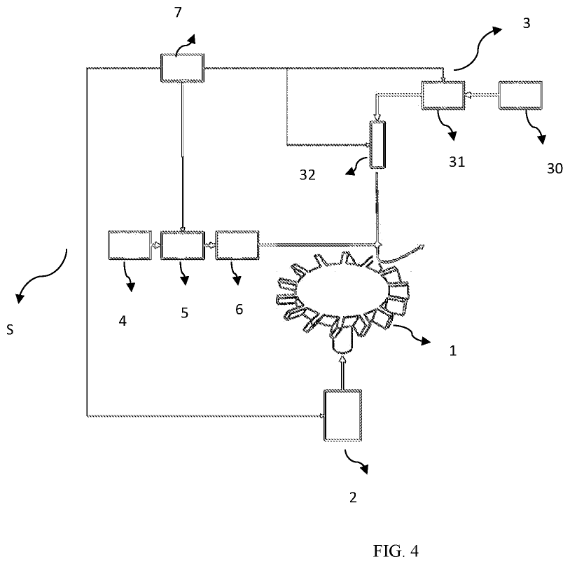

In a preferred embodiment of present invention the atomizer (1) having at least two bodies (10) positioned coaxially with each other is called a cascaded atomizer (FIG. 3) depending on the application requirements to atomize droplet more. When the cascaded atomizer is coupled with a shaft of a jet engine or a power turbine, it can also be used as liquid fuel atomizer. However, this kind of application changes the design of the jet engine. It can also be used as liquid fuel atomizer for internal combustion engines using carburetor.

In a preferred embodiment of present invention an atomization method comprises following steps;
regulating the rotary actuator (2) at a selected speed,
regulating rate of the generated droplets at a selected rate,
controlling flow rate of blowing gas,
atomizing the generated droplets by the blades (12) of the rotating atomizer (1),
directing the atomized droplets by the blowing gas from the gas channel (6).

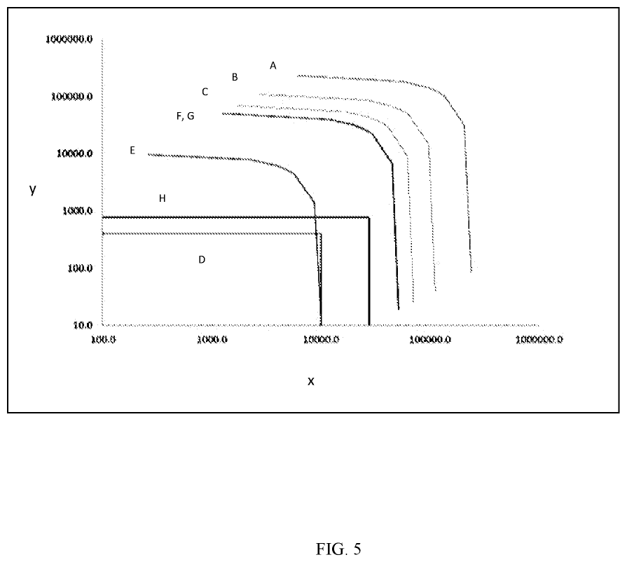

In a preferred embodiment of present invention the higher the inertia of the droplet with respect to surface tension force, the finer will be the atomized droplets. Weber number is the ratio between these two forces. Hence, higher the Weber number, finer will be the atomized droplets. In the FIG. 5, the normal and the tangential Weber numbers are given, for the set-ups in the literature (Aboud & Kietzig, 2015; Almohammadi & Amirfazli, 2017; Bird, Tsai, & Stone, 2009) (FIG. 5: D, E, H) and the present invention for different types of liquids. It is clear that present invention can create very high Weber numbers even for Titanium droplets (G).

It is seen that droplet impact outcome on moving blade (12) can be determined by using normal and tangential Weber number (ρ*V_{n,t}\hat{ }²*D/σ). In this non-dimensional number, ρ is density of the fluid, Vₙ is velocity of the droplet before impact to the blade (12), Vₜ is velocity of the blade (12), D is diameter of droplet before the impact to the blade (12) and σ is surface tension of the liquid. When this is considered and compared with studies (Bird, Tsai, & Stone, 2009, Aboud and Kietzig (2015) and Almohammadi and Amirfazli (2017)) which was done about droplet impact on moving surfaces, it is seen from FIG. 5 that the designed atomizer splits water and molten metal drops into much smaller droplets and it can be used not only with water but also molten metals.

TABLE 1
We_(n, t) calculation data of the present invention (line A In FIG. 5)
Water/surface tension (σ): 0.072 N/m density (ρ): 998.2 kg/m³

| Surface | | |
|---|---|---|
| angle | | |
| (Degree) | We_t | We_n |
| 0 | 238034.4 | 86.6 |
| 20 | 207308.9 | 30812.2 |
| 40 | 135331.1 | 102790.0 |
| 45 | 114613.7 | 123507.3 |
| 50 | 94031.4 | 144089.7 |
| 60 | 55747.5 | 182373.5 |
| 80 | 5760.0 | 232361.0 |

TABLE 2
We_(n, t) calculation data of the present invention (line B In FIG. 5)
Copper/surface tension (σ): 1,374 N/m density (ρ): 8960.00 kg/m³

| Surface | | |
|---|---|---|
| angle | | |
| (Degree) | We_t | We_n |
| 0 | 111963.4 | 40.8 |
| 20 | 97511.1 | 14493.0 |
| 40 | 63655.2 | 48348.9 |
| 45 | 53910.4 | 58093.7 |
| 50 | 44229.2 | 67774.9 |
| 60 | 26221.8 | 85782.4 |
| 80 | 2709.3 | 109294.8 |

TABLE 3
We_(n, t) calculation data of the present invention (line C In FIG. 5)
Iron/surface tension (σ): 1,909 N/m density (ρ): 7874.00 kg/m³

| Surface | | |
|---|---|---|
| angle | | |
| (Degree) | We_t | We_n |
| 0 | 70818.1 | 25.8 |
| 20 | 61676.9 | 9167.0 |
| 40 | 40262.6 | 30581.2 |
| 45 | 34099.0 | 36744.9 |
| 50 | 27975.5 | 42868.4 |
| 60 | 16585.6 | 54258.3 |
| 80 | 1713.7 | 69130.2 |

TABLE 4
Range of We_(n, t) in the work of Almohammadi and Amirfazli (2017)
(line D In FIG. 5)
Water/surface tension (σ): 0.072 N/m density (ρ): 998.2 kg/m³

| We_t | We_n |
|---|---|
| 10000.00 | 1.00 |
| 10000.00 | 400.00 |
| 1.00 | 400.00 |

TABLE 5
Range of We_(n, t) in the work of Aboud and Kietzig (2015)
(line E In FIG. 5)
Aluminum/surface tension (σ): 0.89 N/m density (ρ): 2700 kg/m³

| Surface | | |
|---|---|---|
| angle | | |
| (Degree) | We_t | We_n |
| 0 | 10106.8 | 11.0 |
| 20 | 8712.9 | 1404.9 |
| 40 | 5610.9 | 4506.8 |
| 45 | 4729.7 | 5388.0 |
| 50 | 3858.6 | 6259.2 |
| 60 | 2250.9 | 7866.9 |
| 80 | 203.5 | 9914.3 |

TABLE 6
We_(n, t) calculation data of the present invention (line F In FIG. 5)
Aluminum/surface tension (σ): 0.89 N/m density (ρ): 2700 kg/m³

| Surface | | |
|---|---|---|
| angle | | |
| (Degree) | We_t | We_n |
| 0 | 238034.4 | 86.6 |
| 20 | 207308.9 | 30812.2 |
| 40 | 135331.1 | 102790.0 |
| 45 | 114613.7 | 123507.3 |
| 50 | 94031.4 | 144089.7 |
| 60 | 55747.5 | 182373.5 |
| 80 | 1260.4 | 50845.4 |

TABLE 7
We_(n, t) calculation data of the present invention (line G In FIG. 5)
Titanium/surface tension (σ): 1.51 N/m density (ρ): 4506.00 kg/m³

| Surface | | |
|---|---|---|
| angle | | |
| (Degree) | We_t | We_n |
| 0 | 51235.3 | 18.7 |
| 20 | 44621.8 | 6632.1 |
| 40 | 29129.1 | 22124.8 |
| 45 | 24669.8 | 26584.1 |
| 50 | 20239.6 | 31014.3 |
| 60 | 11999.3 | 39254.6 |
| 80 | 1239.8 | 50014.1 |

TABLE 8
Range of We_(n, t) in the work of Bird, Tsai, & Stone, (2009)
(line H In FIG. 5)
Ethanol/surface tension (σ): 0.023 N/m density (ρ): 790.0 kg/m³

| We_t | We_n |
|---|---|
| 27700.00 | 1.00 |
| 27700.00 | 770.00 |
| 1.00 | 770.00 |

The present invention can be used in many fields where the atomization is required such in the food industry to produce milk powder or in the injection systems to enhance the effect of the spray such as fuel injections. It can be also used automotive and aerospace industries.

What is claimed is:

1. An atomizer comprising:
at least one body comprising a cylindrical lateral surface;
rotating blades positioned outwardly on the cylindrical lateral surface; and
wherein when the at least one body rotates, droplets provided to the rotating blades are atomized by the rotating blades.

2. The atomizer according to claim 1, wherein the at least one body is in a form of a disc.

3. The atomizer according to claim 1, wherein the rotating blades are positioned at a selected angle and at a selected distance to each other.

4. The atomizer according to claim 1, further comprising at least one connecting shaft integrated with the at least one body for connecting the at least one body to at least one rotary actuator.

5. The atomizer according to claim 1, further comprising at least two body positioned coaxially with each other.

6. An atomization system comprising the atomizer according to claim 1, comprising at least one rotary actuator providing a rotational motion to the atomizer and at least one droplet supplier for providing the droplets to the rotating blades.

7. The atomization system according to claim 6, wherein the at least one rotary actuator is configured to rotate the atomizer in a range between 20000 rpm to 200000 rpm.

8. The atomization system according to claim 6, wherein the at least one droplet supplier comprises
at least one reservoir for keeping a liquid to be atomized,
at least one liquid valve for delivering the liquid from the at least one reservoir to at least one droplet generator, and
wherein the at least one droplet generator is for generating the droplets directed to the rotating blades.

9. (canceled)

10. The atomization system according to claim 6, further comprising a gas channel for blowing a gas on atomized droplets to directly atomized droplets.

11. The atomization system according to claim 10, wherein the gas is received form a gas reservoir.

12. The atomization system according to claim 10, comprising at least one valve regulating a flow rate of the gas.

13. The atomization system according to claim 10, comprising at least one controller for regulating a rotational speed of the at least one rotary actuator, a rate of generated droplets or controlling a flow rate of the gas via at least one valve.

14. An atomization method in the atomization system according to claim 13, comprising the following steps of:
regulating the at least one rotary actuator at a selected speed,
regulating the rate of the generated droplets at a selected rate,
controlling the flow rate of the gas,
atomizing the generated droplets by the rotating blades of the atomizer, and
directing the atomized droplets by the gas from the gas channel.

15. The atomization system according to claim 8, wherein the at least one droplet generator is a spray generator.

16. The atomization system according to claim 8, wherein the at least one droplet generator is a liquid jet.

17. The atomization system according to claim 15, wherein the spray generator is a spray injector or a spray nozzle.

18. The atomization system according to claim 7, wherein the at least one droplet supplier comprises
at least one reservoir for keeping a liquid to be atomized, and
at least one liquid valve for delivering the liquid from the at least one reservoir to at least one droplet generator,
wherein the at least one droplet generator is for generating the droplets directed to the rotating blades.

19. The atomization system according to claim 7, further comprising a gas channel for blowing a gas on atomized droplets to directly atomized droplets.

20. The atomization system according to claim 8, further comprising a gas channel for blowing a gas on atomized droplets to directly atomized droplets.

21. The atomization system according to claim 17, further comprising a gas channel for blowing a gas on atomized droplets to directly atomized droplets.
